(19) United States
(12) Patent Application Publication
(10) Pub. No.: US 2025/0088451 A1
(43) Pub. Date: Mar. 13, 2025

(54) Extended shortest path first computation for anycast prefix segments

(71) Applicant: Ciena Corporation, Hanover, MD (US)

(72) Inventors: Bhupendra Yadav, Ottawa (CA); Prabhu Vaithilingam, Kanata (CA); Vikram Singh Sisodiya, Stittsville (ON); Alwyn Joy George, Harinagar (IN)

(73) Assignee: Ciena Corporation, Hanover, MD (US)

(21) Appl. No.: 18/492,975

(22) Filed: Oct. 24, 2023

(30) Foreign Application Priority Data
Sep. 11, 2023 (IN) 202311060988

(51) Int. Cl. H04L 45/121

(52) U.S. Cl. CPC H04L 45/121

(57) ABSTRACT

Systems and methods for an extended shortest path first computation for anycast prefix segments using a preferred metric-type include receiving an Interior Gateway Protocol (IGP) update with anycast group information therein; creating or updating a record for an anycast group with the anycast group information; computing a route for the anycast group based on a preferred metric associated with the anycast group information; and installing the computed route. The preferred metric can be specifically defined in the anycast group information.

### FIELD OF THE DISCLOSURE

The present disclosure relates generally to networking and computing. More particularly, the present disclosure relates to systems and methods for an extended shortest path first computation for anycast prefix segments.

### BACKGROUND OF THE DISCLOSURE

Segment Routing (SR) is a technology that implements a source routing paradigm. A packet header includes a stack of function identifiers, known as segments, which define an ordered list of functions to be applied to the packet. A segment can represent any instruction, topological, or service-based, and each Segment is represented by a Segment Identifier (SID). A segment can have a local semantic to an SR node or global within an SR domain. These functions include, but are not limited to, the forwarding behaviors to apply successively to the packet, notably destination-based unicast forwarding via a sequence of explicitly enumerated nodes (domain-unique node segments) and links (adjacency segments), and the like. SR allows forcing a flow through any topological path and service chain while maintaining a per-flow state only at the ingress node to the SR domain. Segment Routing is described, e.g., in Fiflsfils et al., RFC 8402, “Segment Routing Architecture,” Internet Engineering Task Force (IETF), July 2018, the contents of which are incorporated herein by reference. In Segment Routing, a path includes segments which are instructions a node executes on an incoming packet.

### BRIEF SUMMARY OF THE DISCLOSURE

The present disclosure relates to systems and methods for an extended shortest path first computation for anycast prefix segments. Anycast prefix segments identify a set of routers in a given topology. Specifically, an anycast segment is a specialized prefix segment where packets addressed to an anycast prefix segment addressed from a source router are forwarded to one or more topologically nearest nodes in a group of anycast nodes. Anycast prefix segments are useful in (1) node redundancy, which helps in routing traffic without changing the label stack, (2) enforcing multi plane or region redundant groups, and the like. An anycast Internet Protocol (IP) address or Segment Identifier (SID) is advertised through an Interior Gateway Protocol (IGP) (e.g., Intermediate System-Intermediate System (IS-IS), Open Shortest Path First (OSPF), etc.) utilizing an IGP metric solely for path computation. However, for flexible traffic engineering and practical use cases, different metrics (e.g., latency, etc.) may also be required for path computation. Accordingly, the present disclosure describes a mechanism to select the metric type to be used for path computation towards anycast prefixes. Specifically, the present disclosure includes a new attribute in an Extended IP Reachability Type-Length-Value (TLV) for a preferred metric type to be advertised over IGP for the anycast group. A Path Computation Engine (PCE) or the like can use this attribute to run path computation using the preferred metric at each node, instead of only using the IGP metric.

In various embodiments, the present disclosure includes a method with steps, a router configured to implement the steps, and a non-transitory computer-readable medium storing instructions for programming circuitry to implement the steps. The steps include receiving an Interior Gateway Protocol (IGP) update with anycast group information therein; creating or updating a record for an anycast group with the anycast group information; computing a route for the anycast group based on a preferred metric associated with the anycast group information; and installing the computed route. The preferred metric can be specifically defined in the anycast group information. The preferred metric can be specifically defined in the anycast group information in a sub-Type-Length-Value (TLV). The preferred metric can be another metric besides an IGP metric. The IGP update can be via an Extended IP Reachability Type-Length-Value (TLV) having a sub-TLV therein specifying the preferred metric. The Extended IP Reachability TLV can be compliant to one of RFC 5305 and RFC 5308. The preferred metric can be specified as delay in the IGP update, and wherein the steps further include causing a delay measurement to obtain delay metrics for the route for the anycast group. The anycast group information can include border nodes sharing a same anycast prefix segment. The anycast group information can include planes of a plurality of nodes sharing a same anycast prefix segment.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a network diagram of a network illustrating a first use case for anycast prefix segments.

FIG. 2 is a network diagram of a network illustrating a second use case for anycast prefix segments.

FIG. 3 is a diagram of an extended IP reachability TLV of type 135 for IPv4 with a new sub-TLV for a preferred metric-type.

FIG. 4 is a diagram of an extended IP reachability TLV of type 236 for IPv6 with a new sub-TLV for a preferred metric-type.

FIG. 5 is a diagram of a system including a Shortest Path First (SPF) database associated with one of the routers PE1, PE2, R1, R2, R3, etc.

FIG. 6 is a flowchart of a process for computing paths associated with an anycast prefix.

FIG. 7 is a flowchart of a process for an extended shortest path first computation for anycast prefix segments using a preferred metric-type.

FIG. 8 is a block diagram of an example implementation of a router, such as forming any of the nodes described herein.

FIG. 9 is a block diagram of an example processing device.

### DETAILED DESCRIPTION OF THE DISCLOSURE

Again, the present disclosure relates to systems and methods for an extended shortest path first computation for anycast prefix segments. The present disclosure includes a new attribute in an Extended IP Reachability Type-Length-Value (TLV) for a preferred metric type to be advertised over IGP for the anycast group. A Path Computation Engine (PCE) or the like can use this attribute to run path computation using the preferred metric at each node, instead of only using the IGP metric.

### Segment Routing Overview

A particular attraction of Segment Routing is that it obviates the need to install and maintain any end-to-end (e2e) path state in the core network. Only the ingress node for a particular flow needs to hold the segment stack, which is applied as the header of every packet of that flow, to define its route through the network. This makes Segment Routing particularly suited to control by a Software-Defined Networking (SDN) model.

Segment Routing can be directly applied to Multiprotocol Label Switching (MPLS) with no change in the forwarding plane. A segment is encoded as an MPLS label. An ordered list of segments is encoded as a stack of labels. The segment to process is on the top of the stack. Upon completion of a segment, the related label is popped from the stack.

Segment Routing can also be applied to the Internet Protocol (IP) v6 architecture, with a new type of routing extension header—for example, the document published in July 2015 as draft-previdi-6man-segment-routing-header (available online at tools.ietf.org/html/draft-previdi-6man-segment-routing-header-08) and RFC 8754, “IPv6 Segment Routing Header (SRH),” March 2020, the contents of both are incorporated by reference. A segment is encoded as an IPv6 address. An ordered list of segments is encoded as an ordered list of IPv6 addresses in the routing extension header. The Segment to process at any point along the path through the network is indicated by a pointer in the routing extension header. Upon completion of a segment, the pointer is incremented. Segment Routing can also be applied to Ethernet, e.g., IEEE 802.1 and variants thereof. There are various benefits asserted for SR, including, for example, scalable end-to-end policy, easy incorporation in IP and SDN architectures, operational simplicity, a balance between distributed intelligence, centralized optimization, and application-based policy creation, and the like.

In loose source routing such as Segment Routing, a source node chooses a path or is provided a path by a Software Defined Networking (SDN) controller or Path Computation Element (PCE) and encodes the chosen path in a packet header as an ordered list of segments. The rest of the network executes the encoded instructions without any further per-flow state. Segment Routing provides full control over the path without the dependency on network state or signaling to set up a path. This makes Segment Routing scalable and straightforward to deploy. Segment Routing (SR) natively supports both IPv6 (SRv6) and MPLS (SR-MPLS) forwarding planes and can co-exist with other transport technologies, e.g., Resource Reservation Protocol (RSVP)-Traffic Engineering (RSVP-TE) and Label Distribution Protocol (LDP).

In Segment Routing, a path includes segments which are instructions a node executes on an incoming packet. For example, segments can include forward the packet according to the shortest path to the destination, forward through a specific interface, or deliver the packet to a given application/service instance). Each Segment is represented by a Segment Identifier (SID). All SIDs are allocated from a Segment Routing Global Block (SRGB) with domain-wide scope and significance, or from a Segment Routing Local Block (SRLB) with local scope. The SRGB includes the set of global segments in the SR domain. If a node participates in multiple SR domains, there is one SRGB for each SR domain. In SRv6, the SRGB is the set of global SRv6 SIDs in the SR domain.

A segment routed path is encoded into the packet by building a SID stack that is added to the packet. These SIDs are popped by processing nodes, and the next SID is used to decide forwarding decisions. A SID can be one of the following types an adjacency SID, a prefix SID, a node SID, a binding SID, and an anycast SID. Each SID represents an associated segment, e.g., an adjacency segment, a prefix segment, a node segment, a binding segment, and an anycast segment.

An adjacency segment is a single-hop, i.e., a specific link. A prefix segment is a multi-hop tunnel that can use equal-cost multi-hop aware shortest path links to reach a prefix. A prefix SID can be associated with an IP prefix. The prefix SID can be manually configured from the SRGB and can be distributed by Open Shortest Path First (OSPF) or Intermediate System-Intermediate System (ISIS). The prefix segment steers the traffic along the shortest path to its destination. A node SID is a special type of prefix SID that identifies a specific node. It is configured under the loopback interface with the loopback address of the node as the prefix. A prefix segment is a global segment, so a prefix SID is globally unique within the segment routing domain. An adjacency segment is identified by a label called an adjacency SID, which represents a specific adjacency, such as egress interface, to a neighboring router. The adjacency SID is distributed by ISIS or OSPF. The adjacency segment steers the traffic to a specific adjacency.

A binding segment represents an SR policy. A head-end node of the SR policy binds a Binding SID (BSID) to its policy. When the head-end node receives a packet with an active segment matching the BSID of a local SR Policy, the head-end node steers the packet into the associated SR Policy. The BSID provides greater scalability, network opacity, and service independence. Instantiation of the SR Policy may involve a list of SIDs. Any packets received with an active segment equal to BSID are steered onto the bound SR Policy. The use of a BSID allows the instantiation of the policy (the SID list) to be stored only on the node or nodes that need to impose the policy. The direction of traffic to a node supporting the policy then only requires the imposition of the BSID. If the policy changes, this also means that only the nodes imposing the policy need to be updated. Users of the policy are not impacted. The BSID can be allocated from the local or global domain. It is of special significance at the head-end node where the policy is programmed in forwarding.

An anycast segment is a type of prefix segment that represents an anycast group. An anycast segment/SID is used for policies or protection. When forwarding traffic to an anycast SID, a node processing the forwarding will pick a device from the anycast group, which is the closest. If the closest device from the anycast group goes away, traffic will automatically switch to the next closest device in the anycast group. An anycast SID also enables load balancing and Equal Cost Multipath (ECMP).

SR-MPLS utilizes MPLS labels for the SID, whereas SRv6 utilizes an IPv6 address for a SID, i.e., when an SRv6 SID is in the Destination Address field of an IPv6 header of a packet, it is routed through an IPv6 network as an IPv6 address. Note, various example embodiments described herein are presented with reference to SR-MPLS, but those skilled in the art will recognize SRv6 is also contemplated.

SR Traffic Engineering (SR-TE) provides a mechanism that allows a flow to be restricted to a specific topological path, while maintaining per-flow state only at the ingress node(s) to the SR-TE path. It uses the Constrained Shortest Path First (CSPF) algorithm to compute paths subject to one or more constraint(s) (e.g., link affinity) and an optimization criterion (e.g., link latency). An SR-TE path can be computed by a head-end of the path whenever possible (e.g., when paths are confined to single IGP area/level) or at a PCE (e.g., when paths span across multiple IGP areas/levels).

### Example Anycast Prefix Use Case 1

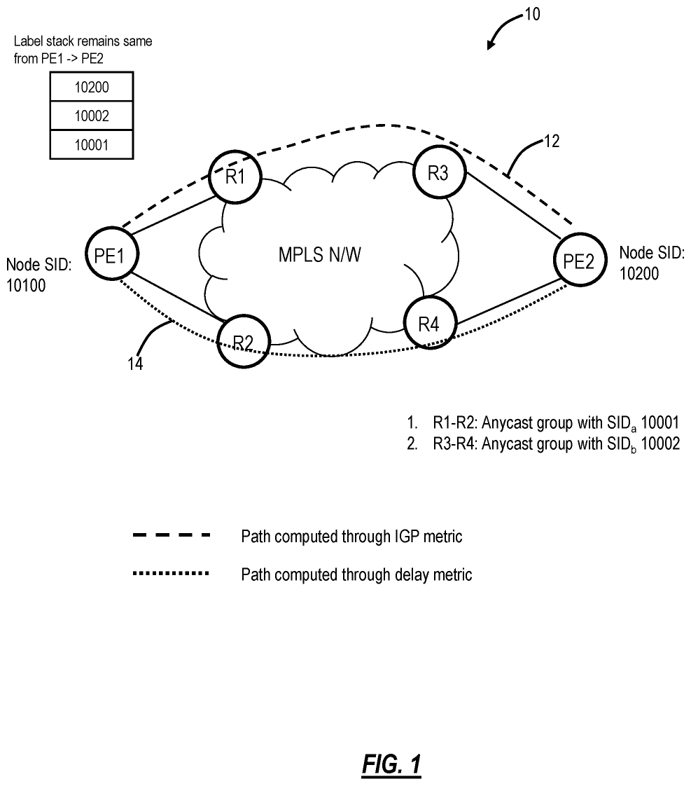

FIG. 1 is a network diagram of a network 10 illustrating a first use case for anycast prefix segments. The network 10 includes routers R1, R2, R3, R4 which are border nodes in an example MPLS network. There are two Provider Edge (PE) routers PE1, PE2 interconnected through the MPLS network with the PE1 router interconnected to both the border nodes R1, R2 and the PE2 router interconnected to both the border nodes R3, R4. The border nodes R1, R2 are configured as part of an anycast group, and the border nodes R3, R4 are also configured as part of an anycast group. In this example, the PE1 router can have a node SID of 10100, the PE2 router can have a node SID of 10200, the border node R1, R2 anycast group can have an anycast prefix SID of 10001, and the border node R3, R4 anycast group can have an anycast prefix SID of 10002.

The path between the PE routers can be computed using different metrics, e.g., the IGP metric, a delay metric, etc., i.e., whatever best suits the application. The IGP metric is a predetermined value assigned to each link, e.g., this can be a value of one per link, an arbitrarily high value if one wishes to a avoid a link, etc. The delay metric can be determined based on a delay measurement, such as using Operations, Administration, and Maintenance (OAM) frames for measuring.

Suppose the PE1 router computes a path towards the PE2 router with the IGP metric, a route 12 from the PE1 router to the router R1 has a lower IGP metric than from the PE1 router to the router R2. Now, suppose the PE1 router computes a path towards the PE2 router with a delay metric, a route 14 from the PE1 router to the router R2 has a lower delay metric than from the PE1 router to the router R1. However, currently there is no mechanism to select a different metric type for SPF computation other than the IGP metric.

### Example Anycast Prefix Use Case 2

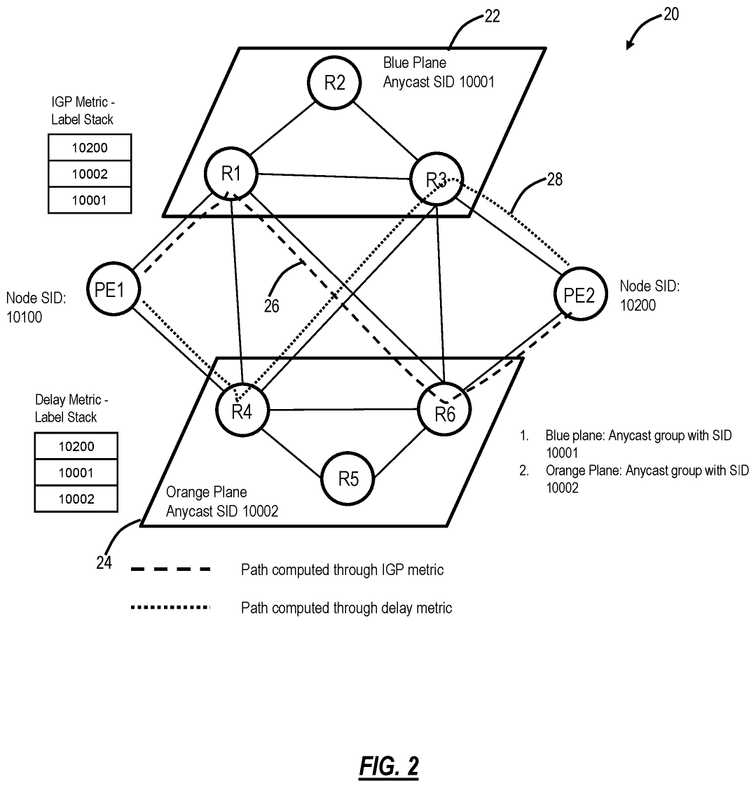

FIG. 2 is a network diagram of a network 20 illustrating a second use case for anycast prefix segments. The network 20 includes two planes 22, 24 distributed as anycast groups. Here, there is a blue plane 22 with routers R1, R2, R3, with an anycast SID of 10001, and an orange plane 24 with routers R4, R5, R6, with an anycast SID of 10002. Again, the path between the PE1 and PE2 routers can be computed using different metrics—IGP metric, delay based on which best suits for the application.

Assume the PE1 router computes a path towards the PE2 router with the IGP metric, a route 26 from the PE1 router to the router R1 has a lower IGP metric than from the PE1 router to the router R2. Now, suppose the PE1 router computes a path towards the PE2 router with a delay metric, a route 28 from the PE1 router to the router R2 has a lower delay metric than from the PE1 router to the router R1. However, currently there is no mechanism to select a different metric type for SPF computation other than the IGP metric.

That is, there is no current approach to use a different metric for determining the shortest path with an anycast segment other than the IGP metric.

### Solution

RFC 5305, “IS-IS Extensions for Traffic Engineering,” October 2008, and RFC 5308, “Routing IPv6 with IS-IS,” October 2008, the contents of each are incorporated by reference in their entirety, describe an IP reachability TLV (also referred to as an extended IP reachability TLV), with a TLV type 135 and type 236 (IPv6 Reachability TLV). The IP reachability TLV can hold sub-TLVs that apply to a particular prefix. This allows for extensions. The IP reachability TLV can include a sub-TLV type 3 which is for an administrative group, and this can be a prefix SID sub-TLV that is advertised for an anycast prefix in this Extended IP reachability TLV.

In the present disclosure, it is possible to define a ‘preferred metric-type’ sub-TLV type within the Extended IP Reachability TLV (type 135) for IPv4 and IP Reachability TLV (type 236) for IPv6, defining the metric to be used for the SPF computation for the given prefix. When no ‘Preferred metric-type’ sub-TLV is present, the default IGP metric can be used for path computation for the Prefix.

The standard IGP Metric-Type is as defined in table below

| Metric- | |
|---|---|
| type | Description |
| 0 | IGP Metric |
| 1 | Min Unidirectional delay as defined in [RFC8570, Section 4.2] |
| | and [RFC7471, Section 4.2] |
| 2 | TE Metric as defined in [RFC5305, Section 3.7] |
| 3 | BW metric (temporary) draft-ietf-lsr-flex-algo-bw-con-05 |
| 4-255 | Unassigned |

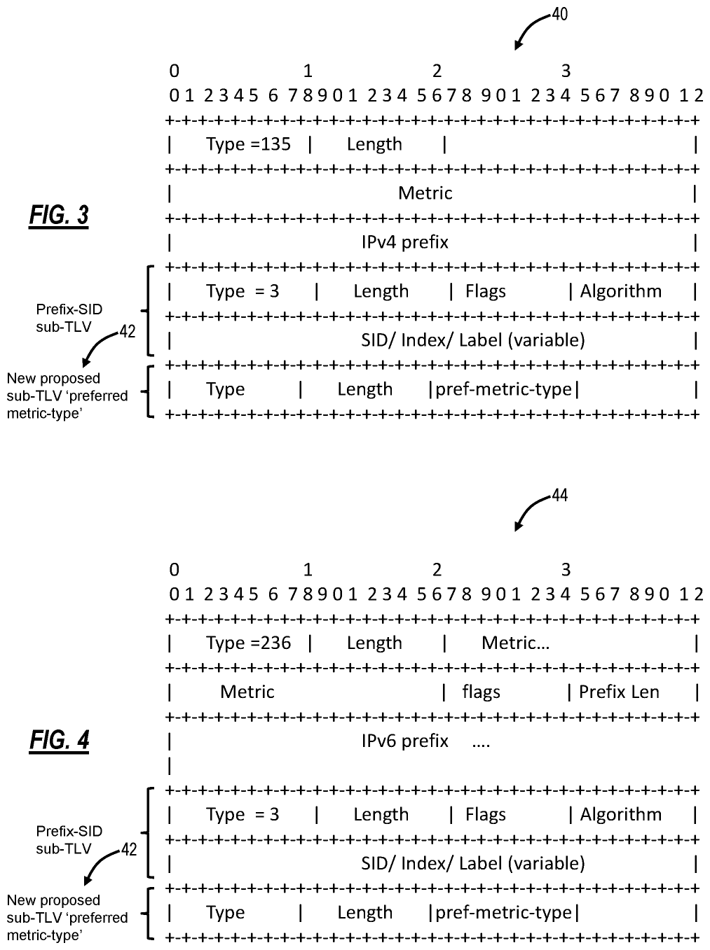

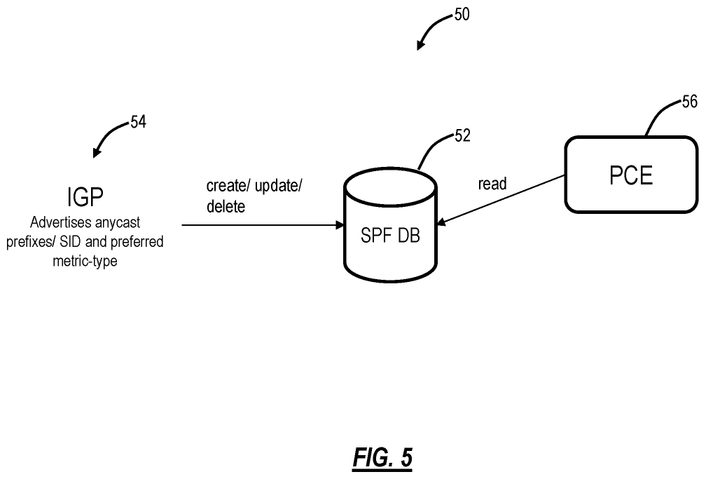

FIG. 3 is a diagram of an extended IP reachability TLV 40 of type 135 for IPv4 with a new sub-TLV 42 for a preferred metric-type. FIG. 4 is a diagram of an extended IP reachability TLV 44 of type 236 for IPv6 with a new sub-TLV 42 for a preferred metric-type. In an embodiment, the preferred metric-type sub-TLV 42 can have a 1 byte preferred-metric-type which could be one of the metric types as defined in the standard, i.e., see the above table, as well as any other predetermined metric type. Those skilled in the art will appreciate the name “preferred metric-type” is merely to describe the sub-TLV 42, and other terminology is contemplated with similar functionality. Also, those skilled in the art will recognize the sub-TLV 42 is just an example implementation, and other implementations are also contemplated with similar functionality.

### Processing of the Sub-TLV

Considering the network 10 in FIG. 1, when an IGP instance (at any of the routers R1, R2, R3, R4, PE1, PE2) receives the above mentioned TLVs 40, 44 with the sub-TLV 42, they will compute the metric required for each node advertising that anycast address. Once the computation is done, it will only program one entry in a Forwarding Information Base (FIB) which fits the metric requirement.

As an example, given a set of nodes {R1, R2} and {R3, R4} advertise an anycast SID of SIDa 10001 and SIDb 10002 want to use latency as metric to all destination nodes in this case PE1 and PE2. Please note, there is no absolute value for the delay metric-type associated here in the sub-TLV 42. The indication in the sub-TLV is only the type of metric to be used. When the routers PE1 or PE2 receive this anycast SID, it will calculate latency to all the nodes in the anycast group {R1, R2} and {R3, R4}. Once the computation is done, it will pick the node with lowest latency and program reachability for destination in the FIB.

### Operational Flow

FIG. 5 is a diagram of a system 50 including a Shortest Path First (SPF) database 52 associated with one of the routers PE1, PE2, R1, R2, R3, etc. IGP 54 advertises anycast prefixes and a preferred metric-type. These are created, updated, deleted, etc. in the SPF database 52 associated with a router. A PCE 56 can read this information in the SPF database 52. The system 50 can be associated with an SR control plane that will use the sub-TLV 42 “Preferred metric-type” in the IP Reachability TLV as follows.
(1) Process the IGP update with Anycast Group(s) Information.
(2) Create and/or update the Anycast Group(s) with this information.
(3) For all non-member routers in the network, compute the routes as follows.
(a) For each anycast group, compute a primary path using SPF with the metric type as “preferred metric type” if it is advertised for all router members of a given anycast group.
(b) For each primary anycast route, compute the backup (e.g., Topology-Independent Loop-Free Alternate (TILFA)) path (using metric type same as used in primary path computation).
(c) If there is another anycast group with different preferred metric-type, do not select it in the SPT (Shortest Path Tree).
(4) Install the computed routes (primary and backup) in the data path/forwarding.

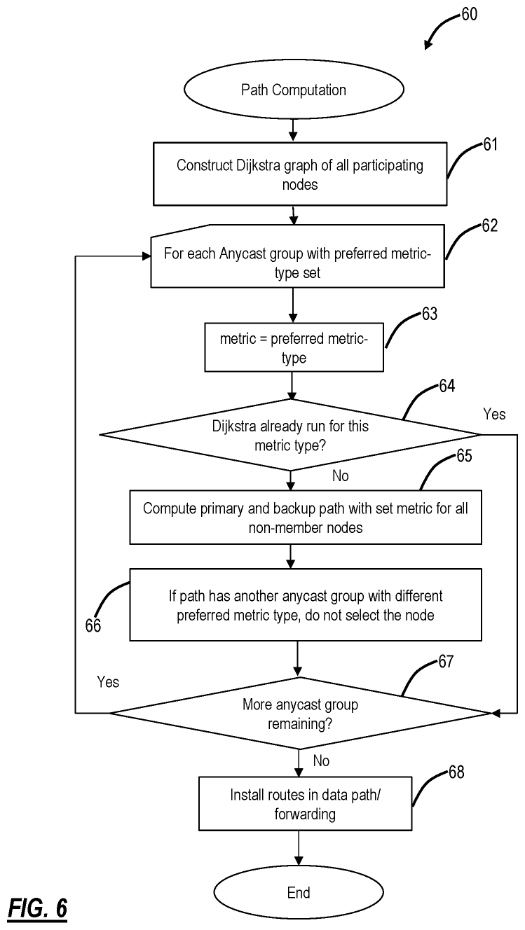

FIG. 6 is a flowchart of a process 60 for computing paths associated with an anycast prefix. The process 60 contemplated implementation as a method having steps, via one of the routers configured to implement the steps, and as a non-transitory computer-readable medium with instructions that, when executed, cause execution of the steps via circuitry. The process 60 contemplates use with the system 50 and the SPF database 52.

For path computation, the process 60 includes constructing a graph to all participating nodes (step 61), such as using Dijkstra's algorithm or some other technique. For each anycast group with a preferred metric-type (step 62), the metric is set to the preferred metric-type (step 63), and the process 60 checks if a graph has already been determined for this metric type (step 64). If not (step 64), the process will compute primary and backup paths with the set metric for all non-member nodes (step 65), and if a path has another anycast group with a different preferred metric-type, the process 60 will not select this node or path (step 66). If there is a graph already been determined for this metric type (step 64) or after the step 66, the process 60 check is there are any more anycast groups remaining (step 67), and if so, returns to step 62, otherwise (step 67), the process 60 includes installing the determined routes in the data path/forwarding (step 68).

### Process

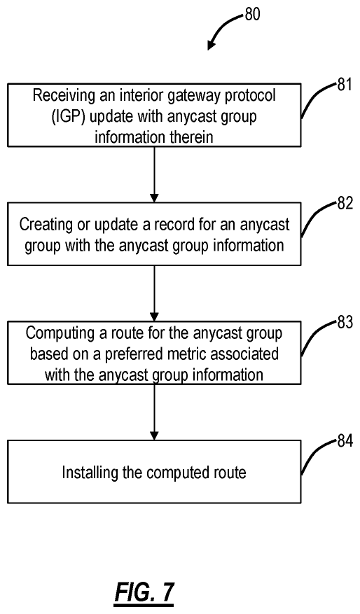

FIG. 7 is a flowchart of a process 80 for an extended shortest path first computation for anycast prefix segments using a preferred metric-type. The process 80 contemplated implementation as a method having steps, via one of the routers configured to implement the steps, and as a non-transitory computer-readable medium with instructions that, when executed, cause execution of the steps via circuitry. The process 80 contemplates use with the system 50 and the SPF database 52.

The steps include receiving an Interior Gateway Protocol (IGP) update with anycast group information therein (step 81); creating or updating a record for an anycast group with the anycast group information (step 82); computing a route for the anycast group based on a preferred metric associated with the anycast group information (step 83); and installing the computed route (step 84).

The preferred metric can be specifically defined in the anycast group information, such as in a sub-Type-Length-Value (TLV). The preferred metric can be another metric besides an IGP metric. The IGP update can be via an Extended IP Reachability Type-Length-Value (TLV) having a sub-TLV therein specifying the preferred metric. The preferred metric can be specified as delay in the IGP update, and wherein the steps further include causing a delay measurement to obtain delay metrics for the route for the anycast group. The anycast group information can include one of (1) border nodes sharing a same anycast prefix segment, and (2) planes of a plurality of nodes sharing a same anycast prefix segment.

### Example Node

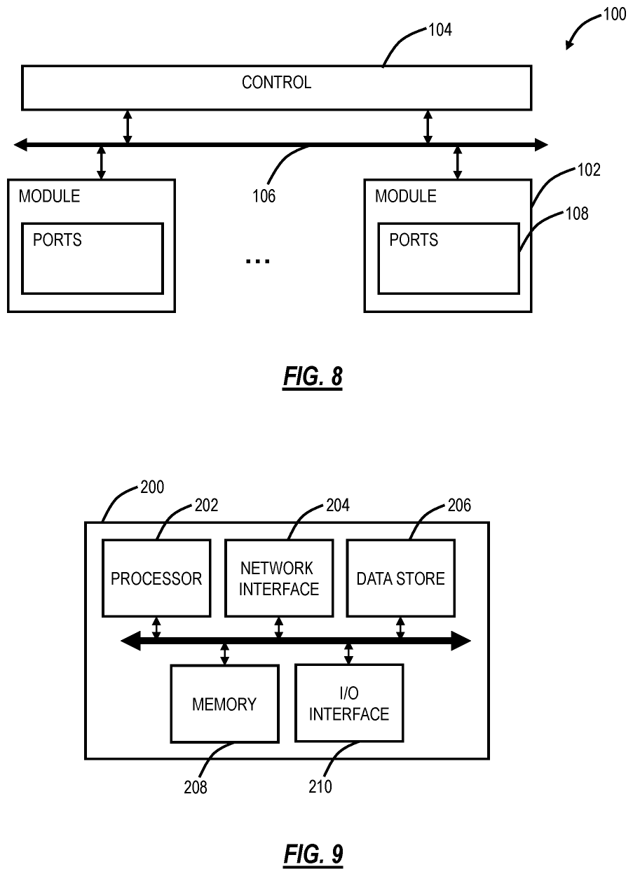

FIG. 8 is a block diagram of an example implementation of a router 100, such as forming any of the nodes described herein. Those of ordinary skill in the art will recognize FIG. 8 is a functional diagram in an oversimplified manner, and a practical embodiment may include additional components and suitably configured processing logic to support known or conventional operating features that are not described in detail herein.

In an embodiment, the router 100 can be any network element or other implementations that support Segment Routing. In this embodiment, the router 100 includes a plurality of modules 102, 104 interconnected via an interface 106. The modules 102, 104 are also known as blades, line cards, line modules, circuit packs, pluggable modules, etc. and generally refer to components mounted on a chassis, shelf, etc. of a data switching device, i.e., the router 100. Each of the modules 102, 104 can include numerous electronic devices and/or optical devices mounted on a circuit board along with various interconnects, including interfaces to the chassis, shelf, etc.

Two example modules are illustrated with line modules 102 and a control module 104. The line modules 102 include ports 108, such as a plurality of Ethernet ports. For example, the line module 102 can include a plurality of physical ports disposed on an exterior of the module 102 for receiving ingress/egress connections. Additionally, the line modules 102 can include switching components to form a switching fabric via the interface 106 between all of the ports 108, allowing data traffic to be switched/forwarded between the ports 108 on the various line modules 102. The switching fabric is a combination of hardware, software, firmware, etc. that moves data coming into the router 100 out by the correct port 108 to the next router 100. “Switching fabric” includes switching/routing units in a node; integrated circuits contained in the switching units; and programming that allows switching paths to be controlled. Note, the switching fabric can be distributed on the modules 102, 104, in a separate module (not shown), integrated on the line module 102, or a combination thereof.

The control module 104 can include a microprocessor, memory, software, and a network interface. Specifically, the microprocessor, the memory, and the software can collectively control, configure, provision, monitor, etc. the router 100. The network interface may be utilized to communicate with an element manager, a network management system, a PCE, etc. Additionally, the control module 104 can include a database that tracks and maintains provisioning, configuration, operational data, and the like.

Again, those of ordinary skill in the art will recognize the router 100 can include other components which are omitted for illustration purposes, and that the systems and methods described herein are contemplated for use with a plurality of different network elements with the router 100 presented as an example type of network element. For example, in another embodiment, the router 100 may include corresponding functionality in a distributed fashion. In a further embodiment, the chassis and modules may be a single integrated unit, namely a rack-mounted shelf where the functionality of the modules 102, 104 is built-in, i.e., a “pizza-box” configuration. That is, FIG. 8 is meant to provide a functional view, and those of ordinary skill in the art will recognize actual hardware implementations may vary; all of which are contemplated herewith.

### Example Controller

FIG. 9 is a block diagram of an example processing device 200. The processing device 200 can be part of the router 100, or a stand-alone device communicatively coupled to the router 100, such as a PCE. Also, the processing device 200 can be referred to in implementations as a control module, a shelf controller, a shelf processor, a system controller, etc. The processing device 200 can be configured to perform the various functions described herein. The processing device 200 can include a processor 202 which is a hardware device for executing software instructions. The processor 202 can be any custom made or commercially available processor, a central processing unit (CPU), an auxiliary processor among several processors associated with the processing device 200, a semiconductor-based microprocessor (in the form of a microchip or chipset), or generally any device for executing software instructions. When the processing device 200 is in operation, the processor 202 is configured to execute software stored within the memory, to communicate data to and from the memory, and to generally control operations of the processing device 200 pursuant to the software instructions. The processing device 200 can also include a network interface 204, a data store 206, memory 208, an I/O interface 210, and the like, all of which are communicatively coupled to one another and to the processor 202.

The network interface 204 can be used to enable the processing device 200 to communicate on a data communication network, such as to communicate to a management system, or the like. The network interface 204 can include, for example, an Ethernet module. The network interface 204 can include address, control, and/or data connections to enable appropriate communications on the network. The data store 206 can be used to store data, such as control plane information, provisioning data, Operations, Administration, Maintenance, and Provisioning (OAM&P) data, etc. The data store 206 can include any of volatile memory elements (e.g., random access memory (RAM, such as DRAM, SRAM, SDRAM, and the like)), nonvolatile memory elements (e.g., ROM, hard drive, flash drive, CDROM, and the like), and combinations thereof.

Moreover, the data store 206 can incorporate electronic, magnetic, optical, and/or other types of storage media. The memory 208 can include any of volatile memory elements (e.g., random access memory (RAM, such as DRAM, SRAM, SDRAM, etc.)), nonvolatile memory elements (e.g., ROM, hard drive, flash drive, CDROM, etc.), and combinations thereof. Moreover, the memory 208 may incorporate electronic, magnetic, optical, and/or other types of storage media. Note that the memory 208 can have a distributed architecture, where various components are situated remotely from one another, but may be accessed by the processor 202. The I/O interface 210 includes components for the processing device 200 to communicate with other devices.

### CONCLUSION

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections may include headers for various embodiments and those skilled in the art will appreciate these various embodiments may be used in combination with one another as well as individually. Further, it is noted that the various elements, operations, steps, methods, processes, algorithms, functions, techniques, etc. described herein can be used in any and all combinations with one another.

What is claimed is:

1. A router comprising circuitry configured to:
receive an Interior Gateway Protocol (IGP) update with anycast group information therein,
create or update a record for an anycast group with the anycast group information,
compute a route for the anycast group based on a preferred metric associated with the anycast group information, and
install the computed route.

2. The router of claim 1, wherein the preferred metric is specifically defined in the anycast group information.

3. The router of claim 2, wherein the preferred metric is specifically defined in the anycast group information in a sub-Type-Length-Value (TLV).

4. The router of claim 1, wherein the preferred metric is another metric besides an IGP metric.

5. The router of claim 1, wherein the IGP update is via an Extended IP Reachability Type-Length-Value (TLV) having a sub-TLV therein specifying the preferred metric.

6. The router of claim 1, wherein the preferred metric is specified as delay in the IGP update, and wherein the circuitry is further configured to perform a delay measurement to obtain delay metrics for the route for the anycast group.

7. The router of claim 1, wherein the anycast group information includes one of (1) border nodes sharing a same anycast prefix segment, and (2) planes of a plurality of nodes sharing a same anycast prefix segment.

8. A non-transitory computer-readable medium comprising instructions that, when executed, cause circuitry, associated with a router, to implement steps of:
receiving an Interior Gateway Protocol (IGP) update with anycast group information therein;
creating or updating a record for an anycast group with the anycast group information;
computing a route for the anycast group based on a preferred metric associated with the anycast group information; and
installing the computed route.

9. The non-transitory computer-readable medium of claim 8, wherein the preferred metric is specifically defined in the anycast group information.

10. The non-transitory computer-readable medium of claim 9, wherein the preferred metric is specifically defined in the anycast group information in a sub-Type-Length-Value (TLV).

11. The non-transitory computer-readable medium of claim 8, wherein the preferred metric is another metric besides an IGP metric.

12. The non-transitory computer-readable medium of claim 8, wherein the IGP update is via an Extended IP Reachability Type-Length-Value (TLV) having a sub-TLV therein specifying the preferred metric.

13. The non-transitory computer-readable medium of claim 8, wherein the preferred metric is specified as delay in the IGP update, and wherein the steps further include
causing a delay measurement to obtain delay metrics for the route for the anycast group.

14. The non-transitory computer-readable medium of claim 8, wherein the anycast group information includes one of (1) border nodes sharing a same anycast prefix segment, and (2) planes of a plurality of nodes sharing a same anycast prefix segment.

15. A method comprising steps of:
receiving an Interior Gateway Protocol (IGP) update with anycast group information therein;
creating or updating a record for an anycast group with the anycast group information;
computing a route for the anycast group based on a preferred metric associated with the anycast group information; and
installing the computed route.

16. The method of claim 15, wherein the preferred metric is specifically defined in the anycast group information.

17. The method of claim 15, wherein the preferred metric is another metric besides an IGP metric.

18. The method of claim 15, wherein the IGP update is via an Extended IP Reachability Type-Length-Value (TLV) having a sub-TLV therein specifying the preferred metric.

19. The method of claim 15, wherein the preferred metric is specified as delay in the IGP update, and wherein the steps further include
causing a delay measurement to obtain delay metrics for the route for the anycast group.

20. The method of claim 15, wherein the anycast group information includes one of (1) border nodes sharing a same anycast prefix segment, and (2) planes of a plurality of nodes sharing a same anycast prefix segment.
